(19) United States
(12) Patent Application Publication
(10) Pub. No.: US 2026/0264759 A1
(43) Pub. Date: Sep. 10, 2026

(54) LOCKING DEVICE OF PREFABRICATED VEHICLE

(71) Applicants: Hyundai Motor Company, Seoul (KR); Kia Corporation, Seoul (KR)

(72) Inventor: Eun Sik Kim, Hwaseong-si (KR)

(21) Appl. No.: 19/226,872

(22) Filed: Jun. 3, 2025

(30) Foreign Application Priority Data
Mar. 5, 2025 (KR) 10-2025-0028442

(51) Int. Cl. B62D 24/00

(52) U.S. Cl. CPC B62D 24/00

(57) ABSTRACT

In an embodiment a locking device includes a locking pin, a pin coupling portion configured to receive the locking pin, a fixed guide having a guide groove configured to guide movement of the locking pin and a rotation guide rotatably installable so that it surrounds the fixed guide, the rotation guide having a locking groove configured to receive an end of the locking pin, wherein the locking pin and the pin coupling portion form a first locking module arrangeable in a cabin portion or a driving portion, wherein the fixed guide and the rotation guide form a second locking module arrangeable in the cabin portion or the driving portion so as to face the first locking module, and wherein the cabin portion is assembled with or disassembled from the driving portion based on the first locking module being coupled to or decoupled from the second locking module.

### CROSS-REFERENCE TO RELATED APPLICATIONS

This application claims priority from Korean Patent Application No. 10-2025-0028442, filed on Mar. 5, 2025, in the Korean Intellectual Property Office, the disclosure of which is incorporated herein by reference in its entirety.

### TECHNICAL FIELD

The present disclosure relates to a locking device for a prefabricated vehicle, and more particularly, to a technique related to a locking device for a prefabricated vehicle, configured to assemble or disassemble a cabin portion (vehicle body portion) through which a passenger is able to enter the vehicle with or from a driving portion (chassis portion).

### BACKGROUND

A purpose built vehicle (PBV) is a vehicle formed by assembling a cabin portion (vehicle body portion) forming various types of boarding and loading spaces in response to market needs with a driving portion (chassis portion) in charge of driving the vehicle.

Therefore, when only the cabin portion is modified depending on the purpose of use of the vehicle, various vehicle models that meet market demand may be manufactured quickly and easily. Accordingly, through modification of the cabin portion, it is possible to effectively respond to market demands through limited production of various vehicle models.

In order to implement the above-described structural configuration of the PBV formed by assembling the cabin portion with the driving portion, it is necessary to provide a new concept of a locking device capable of quickly and readily assembling or disassembling the cabin portion with or from the driving portion.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Embodiments provide a locking device of a prefabricated vehicle, configured to quickly and readily assemble or disassemble a cabin portion through which a passenger is able to enter the vehicle with or from a driving portion for driving the vehicle. Through such a structural configuration of the locking device, convenience of work and productivity may be improved.

Embodiments provide a locking device for a prefabricated vehicle, wherein the locking device includes a locking pin, a pin coupling portion configured for the locking pin to be fixedly coupled thereto, a fixed guide having a guide groove formed therein and configured to guide movement of the locking pin, and a rotation guide rotatably installed in a state of surrounding the fixed guide, the rotation guide having a locking groove formed therein and configured for an end of the locking pin to be inserted thereinto, wherein a first locking module including the locking pin and the pin coupling portion is provided in a cabin portion or a driving portion, a second locking module including the fixed guide and the rotation guide is provided in the cabin portion or the driving portion so as to face the first locking module, and the cabin portion is assembled with or disassembled from the driving portion when the first locking module is coupled to or decoupled from the second locking module.

The pin coupling portions may be fixedly connected to a plurality of portions of the driving portion, respectively, a plurality of the locking pins may be fixedly coupled to each of the pin coupling portions, and both ends of each of the locking pins may protrude outwards from a corresponding one of the pin coupling portions.

The fixed guide may be fixedly coupled to the cabin portion at a location opposite to the pin coupling portion, the pin coupling portion may be inserted into the fixed guide when the first locking module is coupled to the second locking module, the guide groove may be formed to open toward a lower end of the fixed guide and extend upwards, and the end of the locking pin may penetrate the guide groove.

The locking groove may be formed in an inner circumferential surface of the rotation guide, when the locking pin is inserted into the locking groove and is located at an end of the locking groove, the locking pin may be prevented from being separated from the guide groove and the locking groove, the first locking module and the second locking module may be in a coupled state, and the cabin portion and the driving portion may be in an assembled state.

The locking groove may include an entry section formed to open toward a lower end of the rotation guide and extend upwards and a locking section formed to extend in a circumferential direction of the rotation guide from an end of the entry section, one side of the entry section may be formed as an inclined surface, and a locking protrusion may be provided between the inclined surface and the locking section, when the locking pin is located at an end of the locking section, the locking pin may be restricted from moving along the guide groove by the locking protrusion, and when movement of the locking pin is restricted by the locking protrusion, the first locking module and the second locking module may be in the coupled state, and the cabin portion and the driving portion may maintain the assembled state therebetween.

The locking device may further include a return spring having one end coupled to the rotation guide and the other end coupled to the cabin portion so as to provide spring force to the rotation guide.

When the locking pin enters the entry section of the locking groove and moves to a maximum apex of the locking protrusion along the inclined surface, the rotation guide may be rotated clockwise or counterclockwise such that the return spring is elastically deformed, when the locking pin passes through the locking protrusion and enters the locking section, the return spring may return to an initial shape thereof and may transmit elastic force to the rotation guide such that the rotation guide is rotated in an opposite direction, and when the locking pin is located at the end of the locking section by opposite rotation of the rotation guide, the locking pin may be restricted from moving along the guide groove by the locking protrusion.

The rotation guide may have a stopper protrusion formed to protrude outwards in a radial direction of the rotation guide and extend in a circumferential direction thereof, the stopper protrusion may have a locking protrusion having a triangular cross section, the locking protrusion being formed at an end of the stopper protrusion, the cabin portion may have a dome portion formed thereon and configured for the rotation guide to be inserted thereinto, and the dome portion may have a first hole formed for the stopper protrusion to pass therethrough and a second hole and a third hole formed for the locking protrusion to be fixedly locked therein.

The first hole may be formed to circumferentially extend along an outer circumference of the dome portion so as to allow movement of the stopper protrusion when the rotation guide is rotated clockwise or counterclockwise.

The second hole and the third hole may be formed to be sequentially spaced apart from a side portion of the first hole, and when the locking protrusion is fixedly locked in the third hole, the locking pin may not be inserted into the locking groove or may be located at the end of the locking section.

When the locking protrusion is fixedly locked in the third hole, connection between the guide groove and the entry section of the locking groove may be blocked by the locking protrusion, and the locking pin located at the end of the locking section may be restricted from moving along the guide groove by the locking protrusion such that the first locking module and the second locking module maintain the coupled state therebetween, thereby maintaining the assembled state between the cabin portion and the driving portion.

The second hole and the third hole may be formed to be sequentially spaced apart from a side portion of the first hole, and when the locking protrusion is fixedly locked in the second hole, the locking pin may be moved out of the locking protrusion and may be located at a connection point connecting the entry section to the locking section.

When the locking protrusion is fixedly locked in the second hole, the guide groove and the entry section of the locking groove may be connected to each other, and the locking pin may be movable along the guide groove and the entry section of the locking groove, thereby enabling the first locking module to be decoupled from the second locking module and enabling the cabin portion to be separated from the driving portion.

The locking protrusion may be formed to have an inclined surface and a right angle surface, and when the first locking module is decoupled from the second locking module, a tool may be used to remove the locking protrusion locked in the third hole, the rotation guide may be forcibly rotated in a direction toward the second hole, and the locking protrusion may be fixedly inserted into the second hole.

The first locking module and the second locking module may be provided to be exposed to a front space and a rear space of the vehicle, and the front space and the rear space may be respectively opened and closed by a hood and a trunk lid, thereby enabling the first locking module to be coupled to or decoupled from the second locking module by using the tool.

The locking device may further include a motor fixed to the cabin portion and connected to the rotation guide, and the motor may rotate the rotation guide clockwise and counterclockwise during operation thereof.

The rotation guide may be provided with a plurality of spokes extending radially from a central portion of the spokes, and a motor output shaft may be connected to the central portion of the spokes.

The fixed guide may have spoke grooves formed therein and configured for the spokes to be respectively inserted thereinto, and the spoke grooves may restrict, during rotation of the rotation guide, a rotation angle of the rotation guide by allowing movement of the respective spokes and contacting the respective spokes.

When the guide groove and the entry section of the locking groove are connected to each other through rotation of the rotation guide by operation of the motor, the locking pin may be movable along the guide groove and the entry section of the locking groove, thereby enabling the first locking module to be coupled to or decoupled from the second locking module and enabling the cabin portion to be assembled with or disassembled from the driving portion.

In a state in which the guide groove and the entry section of the locking groove are connected to each other such that the locking pin enters the locking section of the locking groove, when the locking pin is located at the end of the locking section through rotation of the rotation guide by operation of the motor, the locking pin may be restricted from moving along the guide groove by the locking protrusion, and when the movement of the locking pin is restricted by the locking protrusion, the first locking module and the second locking module may be in the coupled state, and the cabin portion and the driving portion may maintain the assembled state therebetween.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a state in which a cabin portion and a driving portion are separated from each other in a prefabricated vehicle including a locking device according to the disclosed embodiment;

FIGS. 2 to 19 are views each showing a locking device of an embodiment using a return spring according to the disclosed embodiment;

FIG. 20 is a view showing a state in which the locking device according to the disclosed embodiment is located in a front space and a rear space of the vehicle, which are opened and closed by a hood and a trunk lid, respectively; and

FIGS. 21 to 24 are views each showing a locking device of another embodiment using a motor according to the disclosed embodiment.

### DETAILED DESCRIPTION OF ILLUSTRATIVE EMBODIMENTS

In describing the embodiments disclosed herein, when it is determined that a detailed description of publicly known techniques to which the disclosure pertains may obscure the gist of the present disclosure, the detailed description will be omitted. Further, it should be understood that the accompanying drawings are merely illustrated to easily describe the embodiments disclosed in this specification, and therefore, the technical idea disclosed in this specification is not limited by the accompanying drawings. Further, it should be noted that the accompanying drawings include all modifications, equivalents, and substitutes that fall within the spirit and technical scope of the present disclosure. The disclosure below is not intended to limit the present disclosure to a form described in the present disclosure or to a specific field, and it is contemplated that various alternative aspects and modifications to the present disclosure are possible, whether explicitly described or implied herein. It will be appreciated by those skilled in the art to which the present disclosure pertains that the form and details of the present disclosure may vary.

The present disclosure will be described with reference to embodiments. However, as will be appreciated by those skilled in the art to which the present disclosure pertains, various embodiments disclosed herein may be modified or otherwise implemented in various other ways without departing from the spirit and scope of the disclosure. Accordingly, the following description is to be considered as illustrative and is for the purpose of teaching those skilled in the art the manner of making and using various embodiments. It is to be understood that the forms of disclosure herein shown and described are to be taken as representative embodiments. Equivalent elements, materials, processes, or steps may be substituted for those representatively illustrated and described herein. Expressions such as “including”, “comprising”, “incorporating”, “consisting of”, “have”, and “is” used to describe and claim the present disclosure are intended to be construed in a non-exclusive manner, that is, to allow for items, components or elements not explicitly described also to be present. Reference to the singular is also to be construed to relate to the plural.

Further, various embodiments disclosed herein are to be taken in the illustrative and explanatory sense and should not be construed as limiting the scope of the present disclosure. All references to joining (for example, attached, affixed, coupled, connected, and the like) are only used to aid the reader's understanding of the present disclosure and are not intended to limit the position, orientation, or use of a configuration and/or methods disclosed herein. Therefore, references to joining, if any, are to be construed broadly. Moreover, such references to joining do not necessarily infer that two or more elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to any component, embodiment, variation, and/or modification, or the order or preference thereof. That is, while these expressions may be used to describe various components, the components are not limited by the corresponding expressions. These expressions are used only for the purpose of distinguishing one component from another.

Hereinafter, the suffixes “module”, “unit”, and “part” for components used in the following description are merely provided for facilitation of preparing this specification. Therefore, the suffixes themselves do not have significant meanings or roles.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

In addition, each unit or control unit is only a term widely used in naming a controller for controlling a specific function of the vehicle, and does not mean a generic functional unit.

Examples of the device may include a communication device configured to communicate with other controllers or sensors to control the corresponding function, a non-transitory computer-readable medium configured to store an operating system or logic commands and input/output information, and one or more processors configured to perform determination, calculation, communication, and the like for controlling the corresponding function.

Any number or components or a variety of components in any of the configurations described herein may be included within the disclosure described herein. The components may include any combination of the features described herein and may be arranged in any of the various configurations described herein. The structure and arrangement of the components of the present disclosure, as well as the concepts regarding the use and operation thereof may be applied not only to the specific embodiments discussed herein, but also to any number of embodiments in any combination. Embodiments including those having various features in various arrangements will be described below with reference to the drawings.

Hereinafter, various embodiments disclosed in the present specification will be described in detail with reference to the accompanying drawings. Wherever possible, the same reference numbers will be used throughout the drawings to refer to the same or like parts, and redundant descriptions thereof will be omitted.

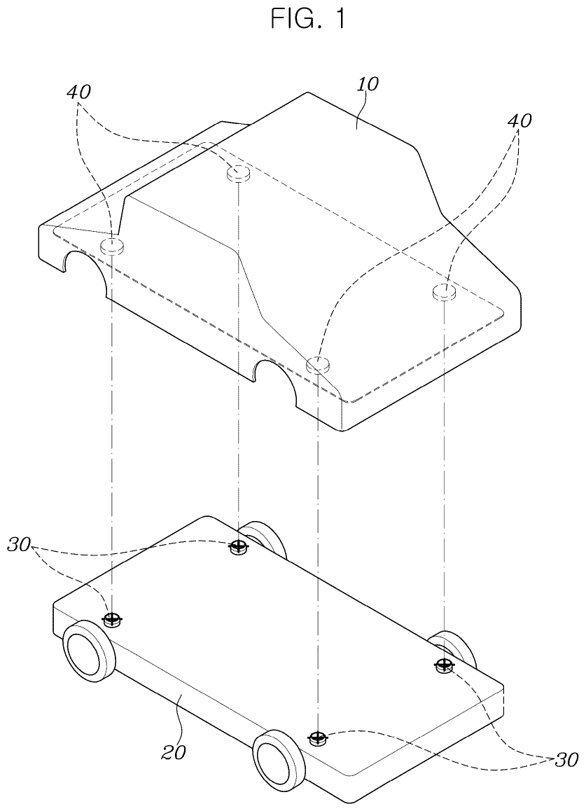

Referring to FIG. 1, a prefabricated vehicle according to a disclosed embodiment has a configuration in which a cabin portion 10 through which a passenger enters the vehicle is assembled with or disassembled from a driving portion 20 in charge of driving the vehicle, and only the cabin portion 10 may be changed depending on the purpose of use of the vehicle.

The driving portion 20 may be formed of a battery module, an engine, wheels, a power transmission system, and the like provided for driving of the vehicle.

A locking device according to the disclosed embodiment may be used to assemble or disassemble the cabin portion 10 with or from the driving portion 20.

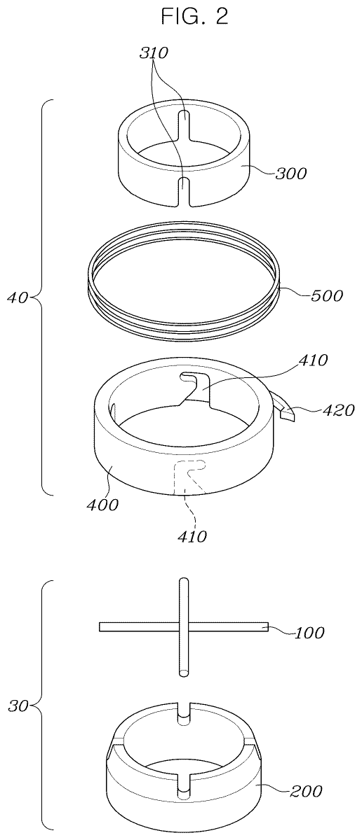

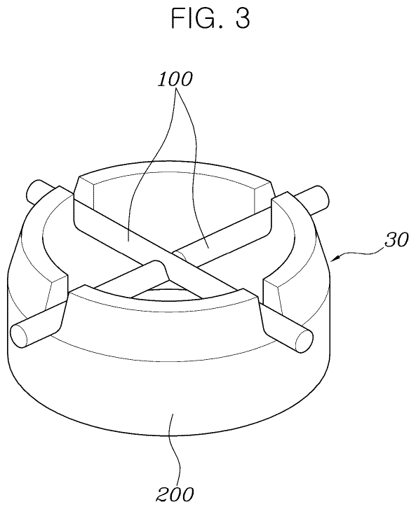

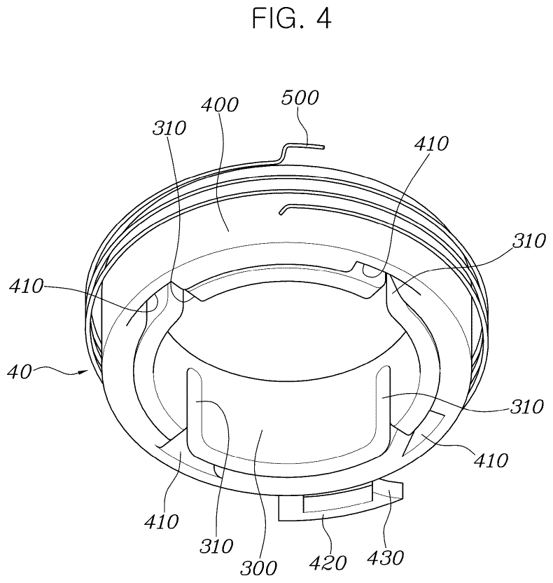

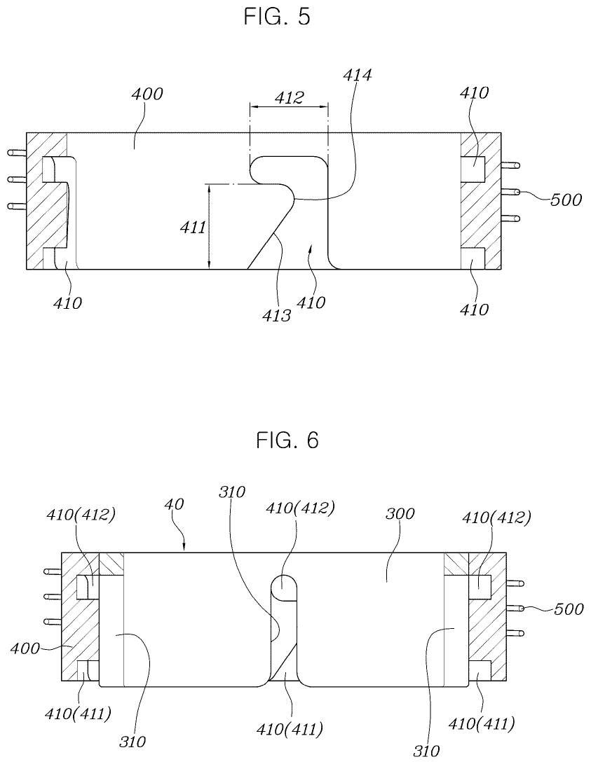

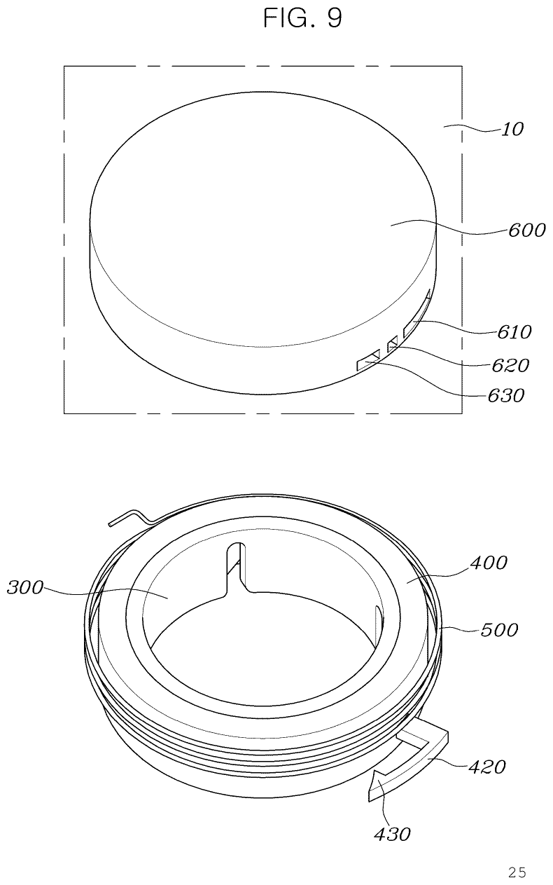

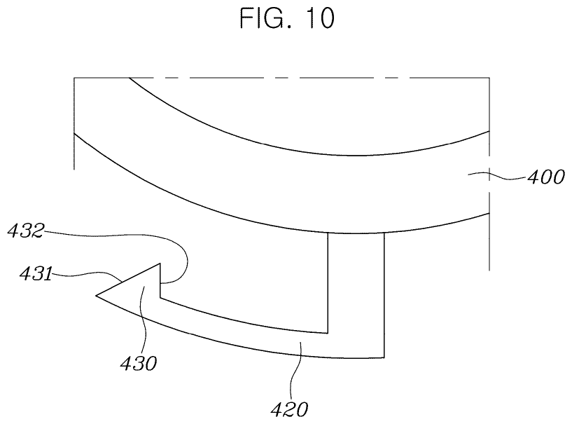

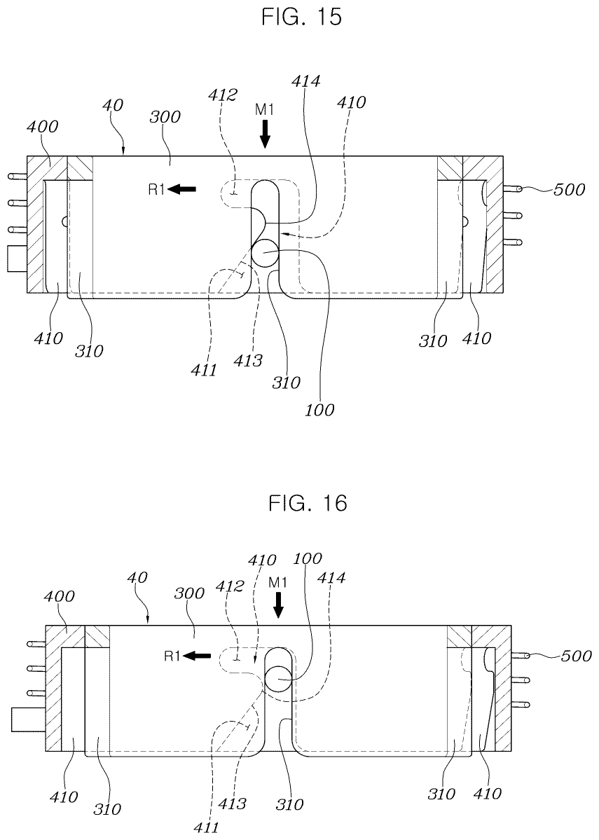

The locking device of the prefabricated vehicle according to the disclosed embodiment will be described with reference to FIGS. 1 to 20.

The locking device of the prefabricated vehicle according to the disclosed embodiment may include a first locking module 30 provided in the cabin portion 10 or the driving portion 20 and a second locking module 40 provided in the cabin portion 10 or the driving portion 20.

Each of the first locking module 30 and the second locking module 40 may be provided in plural, and each of the first locking modules 30 may be coupled to or decoupled from a corresponding one of the second locking modules 40.

A plurality of first locking modules 30 may be provided in in the cabin portion 10 or the driving portion 20. In the disclosed embodiment, the plurality of first locking modules 30 may be provided in the driving portion 20.

A plurality of second locking modules 40 may be provided in the cabin portion 10 or the driving portion 20 in which the first locking modules 30 are not provided. In the disclosed embodiment, the plurality of second locking modules 40 may be provided in the cabin portion 10.

The first locking module 30 may include a plurality of locking pins 100 and a pin coupling portion 200 to which the locking pins 100 are fixedly coupled.

Each of the locking pins 100 is formed to have a straight line shape, and two locking pins may be connected to each other in a cross shape.

A cross-sectional thickness of a middle portion at which the two locking pins 100 intersect each other is the same as a cross-sectional thickness of one locking pin 100. Through such a structural configuration, the locking pins 100 may maximally reduce the layout size according to a coupling structure thereof and may provide a compact configuration while maximally increasing strength and rigidity.

The pin coupling portion 200 is formed as a cylindrical pipe. Here, the lower portion of the pin coupling portion 200 may be fixedly coupled to the driving portion 20, and the upper portion thereof may be fixedly coupled to the locking pins 100 by welding or other methods.

The locking pins 100 may be coupled to the pin coupling portion 200 by crossing the pin coupling portion 200 in the radial direction, and both ends of each of the locking pins 100 may protrude outwards from the pin coupling portion 200.

The second locking module 40 may include a fixed guide 300 having a guide groove 310 formed for the end of the locking pin 100 to be inserted thereinto and configured to guide movement of the locking pin 100, and a rotation guide 400 rotatably installed in a state of surrounding the fixed guide 300 and formed to have a locking groove 410 configured for the end of the locking pin 100 to be inserted thereinto.

The fixed guide 300 may be formed as a cylindrical pipe, and an upper end thereof may be fixedly coupled to the cabin portion 10. Here, the upper end may be fixedly coupled to the cabin portion 10 at a location opposite to the pin coupling portion 200.

The guide groove 310 may be formed to have a straight line shape that opens toward the lower end of the fixed guide 300 and extends upwards.

The number of the guide grooves 310 is configured to be the same as the number of ends of the locking pin 100, which protrude outwards from the pin coupling portion 200. That is, the ends of the locking pin 100, which protrude outwards from the pin coupling portion 200, may respectively penetrate the guide grooves 310.

When the first locking module 30 and the second locking module 40 are coupled to each other, the pin coupling portion 200 may be inserted into the inner side of the fixed guide 300.

The rotation guide 400 may be formed as a cylindrical pipe, and the fixed guide 300 may be inserted into the inner space of the rotation guide 400.

The rotation guide 400 may be installed in a rotatable structure in a state of surrounding the fixed guide 300 through coupling between a dome portion 600 formed on the cabin portion 10 and a stopper protrusion 420 and a locking protrusion 430 provided on the rotation guide 400. In this manner, the rotation guide 400 may be prevented from being separated from the cabin portion 10.

The locking groove 410 may be formed in the inner circumferential surface of the rotation guide 400, may be formed to be open toward the lower end of the rotation guide 400, and may be formed in the same number as the number of the ends of the locking pin 100, which protrude through the respective guide grooves 310.

When the first locking module 30 and the second locking module 40 are coupled to each other, the ends of the locking pin 100, which protrude through the respective guide grooves 310, may be inserted into the respective locking grooves 410.

According to the disclosed embodiment, the first locking module 30 may be coupled to or decoupled from the second locking module 40 in a one-to-one matching manner. When the first locking module 30 and the second locking module 40 are coupled to each other, the cabin portion 10 and the driving portion 20 are assembled with each other. Conversely, when the coupled first locking module 30 and the second locking module 40 are disassembled from each other, the cabin portion 10 and the driving portion 20 may be separated from each other.

When the first locking module 30 and the second locking module 40 are coupled to each other, the locking pin 100 is inserted into the locking groove 410 and is located at the end of the locking groove 410. In this manner, the locking pin 100 may be prevented from being separated from the guide groove 310 and the locking groove 410, the first locking module 30 and the second locking module 40 may be in the coupled state, and the cabin portion 10 and the driving portion 20 may be in the assembled state.

The locking groove 410 may include an entry section 411 that opens toward the lower end of the rotation guide 400 and extends upwards, and a locking section 412 that extends in the circumferential direction of the rotation guide 400 from the end of the entry section 411. One side of the entry section 411 may be formed as an inclined surface 413, and a locking protrusion 414 protruding toward the locking groove 410 may be provided between the inclined surface 413 and the locking section 412.

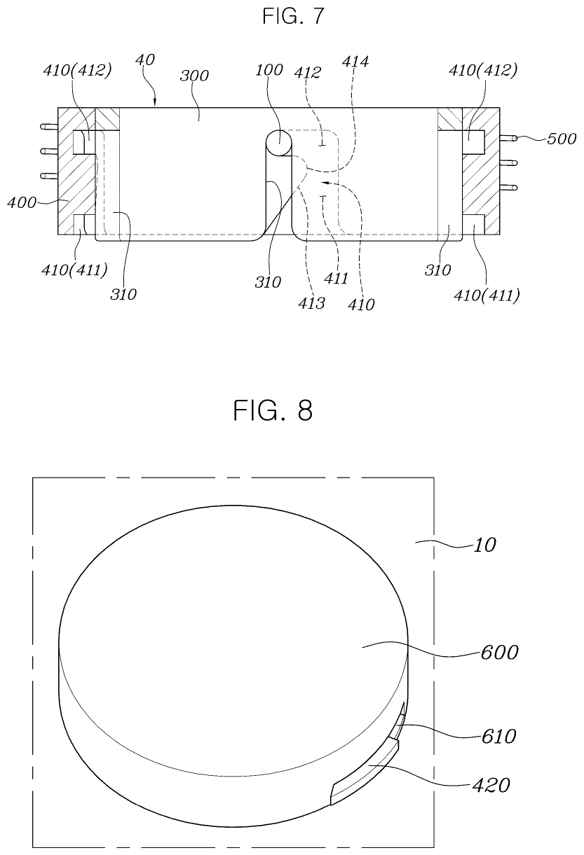

As shown in FIGS. 7 and 17, when the locking pin 100 is located at the end of the locking section 412, the locking pin 100 is restricted from moving along the guide groove 310 by the locking protrusion 414. For example, when movement of the locking pin 100 is restricted by the locking protrusion 414, the first locking module 30 and the second locking module 40 are in the coupled state, and the assembled state between the cabin portion 10 and the driving portion 20 may be maintained.

The locking device according to the disclosed embodiment may further include a return spring 500 having one end coupled to the rotation guide 400 and the other end coupled to the cabin portion 10 so as to provide spring force to the rotation guide 400.

The return spring 500 may be formed as a torsion spring.

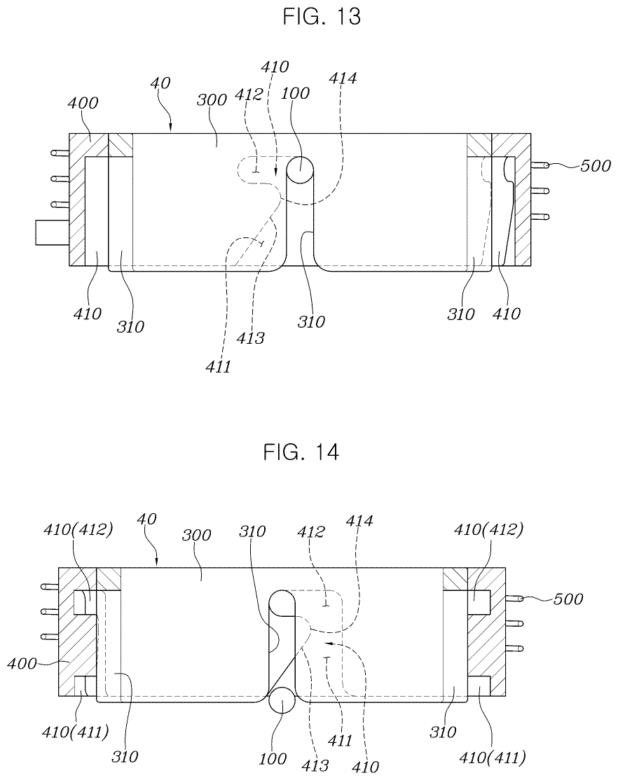

Referring to FIGS. 14 to 16, in order to couple the first locking module 30 to the second locking module 40, when the locking pin 100 enters the entry section 411 of the locking groove 410 and moves to the maximum apex of the locking protrusion 414 along the inclined surface 413, the rotation guide 400 is rotated clockwise or counterclockwise, and, for example, the return spring 500 may be compressed.

An arrow M1 indicates a direction in which the second locking module 40 is moved to be coupled to the first locking module 30, and an arrow R1 indicates a direction in which the rotation guide 400 is rotated when the locking pin 100 enters the entry section 411 of the locking groove 410 and moves to the maximum apex of the locking protrusion 414 along the inclined surface 413.

Next, when the locking pin 100 passes through the locking protrusion 414 and enters the locking section 412 (a location at which the locking pin 100 is indicated by a dotted line in FIG. 17), the return spring 500 is decompressed to transmit elastic force to the rotation guide 400, and the rotation guide 400 receives the elastic force of the return spring 500 and is rotated in the opposite direction, as shown by an arrow R2 in FIG. 17.

When the locking pin 100 is located at the end of the locking section 412 by opposite rotation of the rotation guide 400 as shown in FIG. 17, the locking pin 100 is restricted from moving along the guide groove 310 by the locking protrusion 414. In this state, when movement of the locking pin 100 is restricted by the locking protrusion 414, the first locking module 30 and the second locking module 40 are in the coupled state, and the cabin portion 10 and the driving portion 20 may maintain the assembled state therebetween.

The rotation guide 400 may be formed to have the stopper protrusion 420 that protrudes outwards in the radial direction thereof and extends in the circumferential direction, and the locking protrusion 430 having a triangular cross section may be formed at the end of the stopper protrusion 420.

The locking protrusion 430 formed in the triangular cross section may be formed to have an inclined surface 431 and a right angle surface 432 each provided on the outer surface thereof.

The dome portion 600 into which the rotation guide 400 is inserted may be formed on the cabin portion 10.

The dome portion 600 may be formed to protrude from the cabin portion 10 in a circular groove identical to the rotation guide 400, and the rotation guide 400 may be inserted into the inner side of the dome portion 600 so as to be installed therein in a rotatable structure.

The outer circumferential surface of the dome portion 600 may be formed to have a first hole 610 through which the stopper protrusion 420 passes, and a second hole 620 and a third hole 630 formed for the locking protrusion 430 to be fixedly locked therein.

The first hole 610 through which the stopper protrusion 420 passes may be formed to circumferentially extend along the outer circumference of the dome portion 600 so as to allow movement of the stopper protrusion 420 when the rotation guide 400 is rotated clockwise or counterclockwise.

The second hole 620 and the third hole 630 may be formed to be sequentially spaced apart from a side portion of the first hole 610.

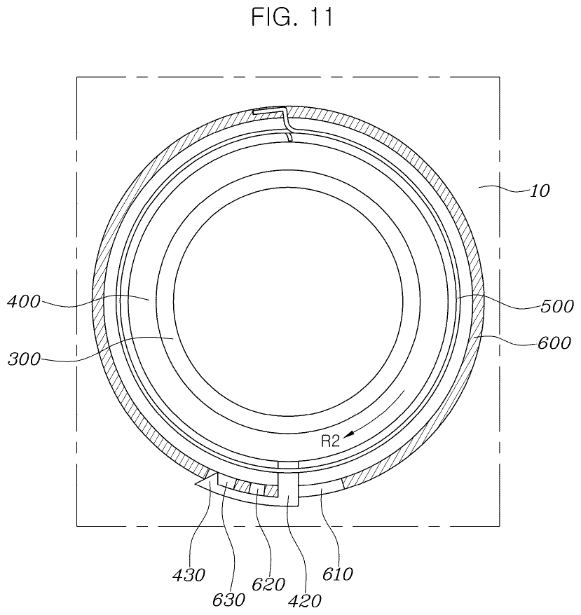

As shown in FIG. 11, the locking protrusion 430 is fixedly locked in the third hole 630. In this state, as shown in FIG. 14, the locking pin 100 may not be inserted into the locking groove 410, or as shown in FIGS. 7 and 17, the locking pin 100 may be located at the end of the locking section 412.

When the locking protrusion 430 is fixedly locked in the third hole 630, connection between the guide groove 310 and the entry section of the locking groove 410 is blocked by the locking protrusion 414, and the locking pin 100 located at the end of the locking section 412 is restricted from moving along the guide groove 310 by the locking protrusion 414 such that the first locking module 30 and the second locking module 40 may maintain the coupled state therebetween, thereby maintaining the assembled state between the cabin portion 10 and the driving portion 20.

An arrow R2 shown in FIG. 11 is a direction in which the rotation guide 400 is rotated by spring force of the return spring 500.

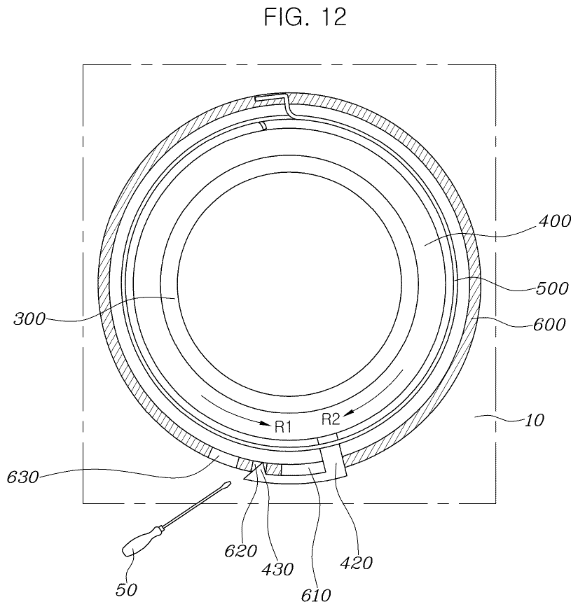

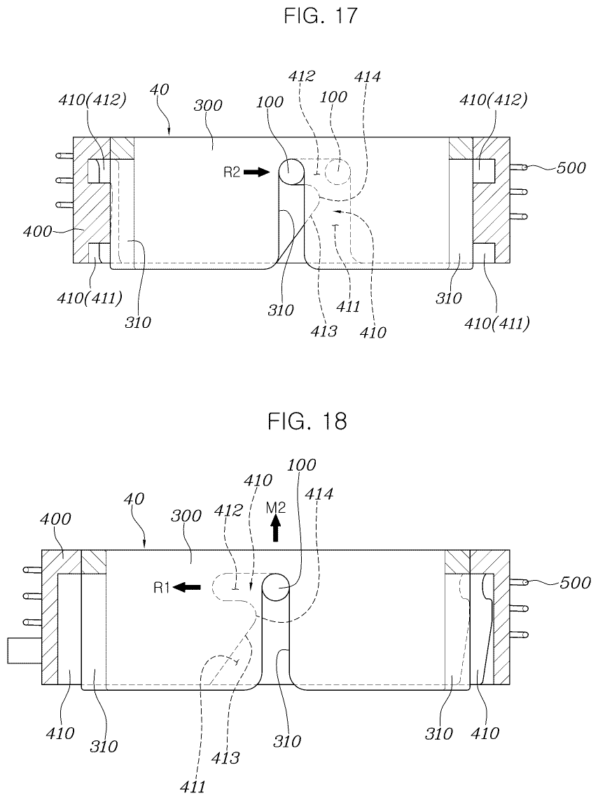

As shown in FIG. 12, when the locking protrusion 430 is fixedly locked in the second hole 620, the locking pin 100 may be moved out of the locking protrusion 414 and may be located at a connection point connecting the entry section 411 to the locking section 412, as shown in FIG. 18.

When the locking protrusion 430 is fixedly locked in the second hole 620, the guide groove 310 and the entry section 411 of the locking groove 410 are connected to each other, as shown in FIG. 18, and the locking pin 100 may be moved along the guide groove 310 and the entry section 411 of the locking groove 410, thereby enabling the first locking module 30 to be decoupled from the second locking module 40 and enabling the cabin portion 10 to be separated from the driving portion 20.

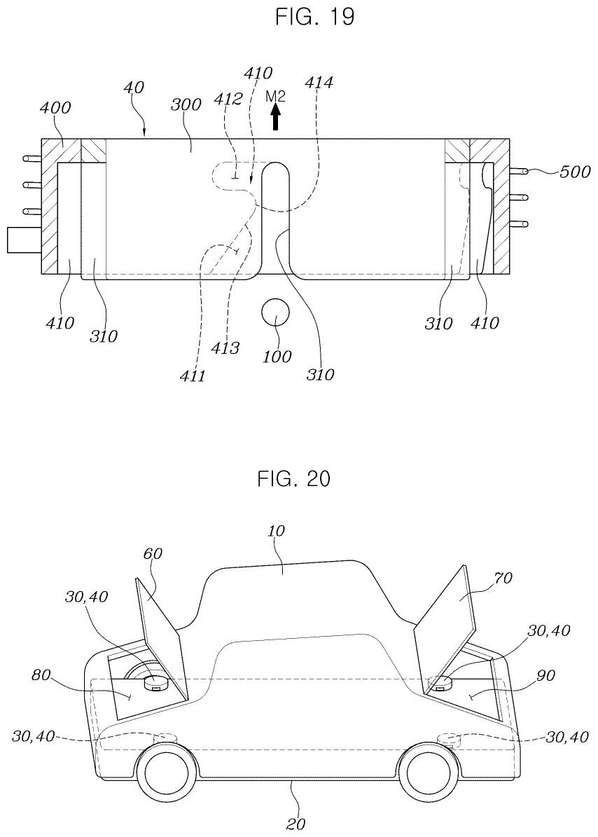

As shown in FIGS. 18 and 19, when the second locking module 40 is moved upwards, as shown by an arrow M2, in a state in which the guide groove 310 and the entry section 411 of the locking groove 410 are connected to each other, the locking pin 100 may be moved along the guide groove 310 and the entry section 411 of the locking groove 410, thereby enabling the first locking module 30 to be decoupled from the second locking module 40 and enabling the cabin portion 10 to be separated from the driving portion 20.

The locking protrusion 430 may be formed to have the inclined surface 431 and the right angle surface 432.

When the first locking module 30 is decoupled from the second locking module 40, as shown in FIG. 12, a tool 50 is used to remove the locking protrusion 430 locked in the third hole 630. Thereafter, the rotation guide 400 may be forcibly rotated in a direction toward the second hole 620, as shown by the arrow R1, and the locking protrusion 430 may be fixedly inserted into the second hole 620.

When the locking protrusion 430 is fixedly locked in the second hole 620, the guide groove 310 and the entry section 411 of the locking groove 410 are connected to each other. When the second locking module 40 is moved upwards, as shown by the arrow M2, the locking pin 100 may be moved along the guide groove 310 and the entry section 411 of the locking groove 410, thereby enabling the first locking module 30 to be decoupled from the second locking module 40 and enabling the cabin portion 10 to be separated from the driving portion 20.

Referring to FIG. 20, the first locking module 30 and the second locking module 40 may be provided to be exposed to a front space 80 and a rear space 90 of the vehicle, which are opened and closed by a hood 60 and a trunk lid 70, respectively. A worker may readily couple or decouple the first locking module 30 to or from the second locking module 40 by using the tool 50 after opening the hood 60 and the trunk lid 70.

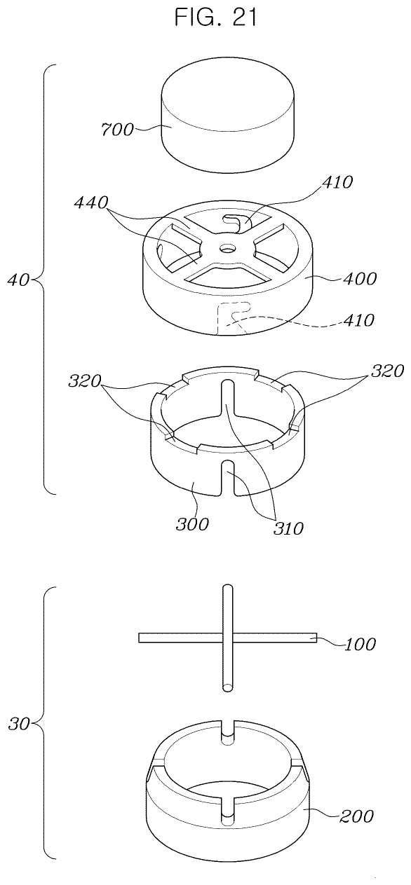

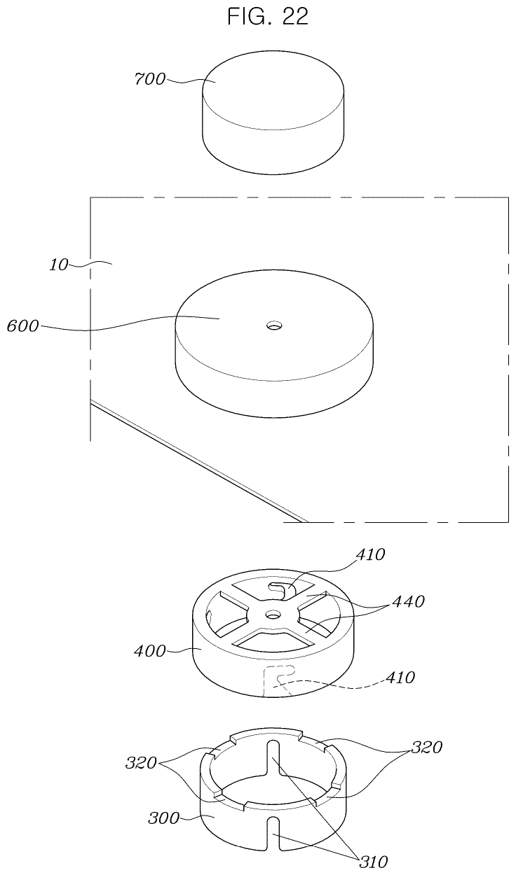

A locking device of a prefabricated vehicle according to another disclosed embodiment will be described with reference to FIGS. 21 to 24.

A locking device of one embodiment is characterized by a structural configuration in which the first locking module 30 is coupled to the second locking module 40 in a one-touch manner through rotation of the rotation guide 400 without using power, and a locking device of another embodiment is characterized by a structural configuration in which the rotation guide 400 is rotated by a motor 700.

According to another embodiment, the configuration of the first locking module 30 including the locking pin 100 and the pin coupling portion 200 is the same as that of the above-described embodiment, and thus a description of the first locking module 30 will be omitted.

As described above, the second locking module 40 of one embodiment is configured to include the fixed guide 300, the rotation guide 400, and the return spring 500. Meanwhile, the second locking module 40 of another embodiment includes the fixed guide 300, the rotation guide 400, and the motor 700, and is configured to rotate the rotation guide 400 by using the motor 700 instead of using the return spring 500 of one embodiment.

In various embodiments, the motor 700 is a bidirectional motor capable of being rotated both clockwise and counterclockwise, but the present disclosure is not limited thereto.

The basic configuration of the fixed guide 300 having the guide groove 310 formed therein and the basic configuration of the rotation guide 400 having the locking groove 410 formed therein in the second locking module 40 are the same as those of one embodiment, and thus detailed descriptions thereof will be omitted.

According to the disclosed embodiment, the rotation guide 400 may be provided with a plurality of spokes 440 extending radially from a central portion of the spokes, and a motor output shaft 710 provided in the motor 700 may be connected to the central portion of the spokes 440.

The motor 700 may be fixedly installed in the dome portion 600 provided on the cabin portion 10, and the motor output shaft 710 may be coupled to the central portion of the spokes 440 of the rotation guide 400 located in the dome portion 600 by penetrating the dome portion 600.

When the motor 700 is operated, rotational power of the motor 700 is transmitted to the rotation guide 400 through the motor output shaft 710, thereby rotating the rotation guide 400.

Spoke grooves 320 into which the spokes 440 are respectively inserted may be formed in the fixed guide 300. Here, the spoke grooves 320 may serve to restrict the rotation angle of the rotation guide 400 by contacting the respective spokes 440 while allowing movement of the respective spokes 440 during rotation of the rotation guide 400.

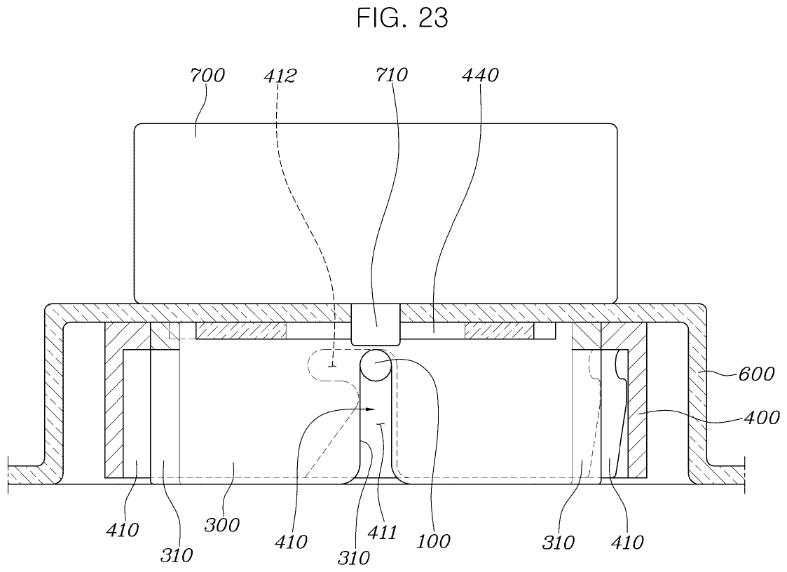

Referring to FIG. 23, when the guide groove 310 and the entry section 411 of the locking groove 410 are connected to each other through rotation of the rotation guide 400 by operation of the motor 700, the locking pin 100 may be moved along the guide groove 310 and the entry section 411 of the locking groove 410, thereby enabling the first locking module 30 to be coupled to or decoupled from the second locking module 40 and enabling the cabin portion 10 to be assembled with or disassembled from the driving portion 20.

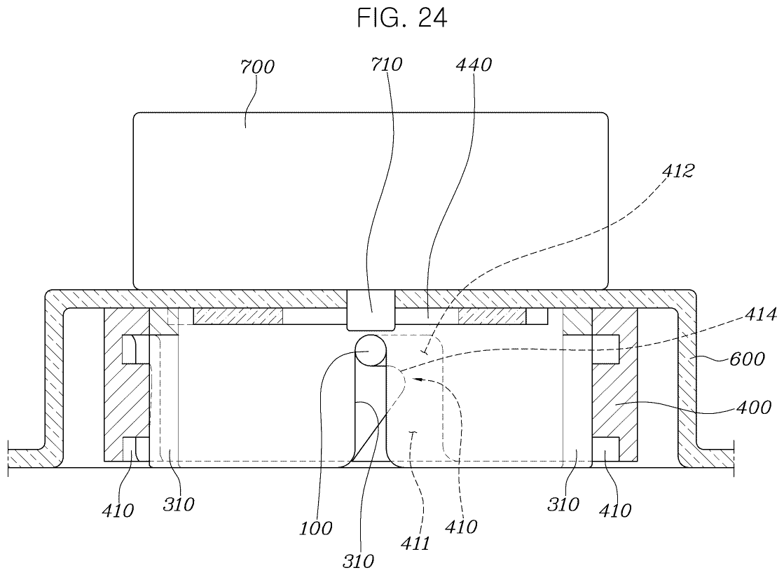

Further, as shown in FIG. 23, in a state in which the guide groove 310 and the entry section 411 of the locking groove 410 are connected to each other such that the locking pin 100 enters the locking section 412 of the locking groove 410, when the locking pin 100 is located at the end of the locking section 412, as shown in FIG. 24, through rotation of the rotation guide 400 by operation of the motor 700, the locking pin 100 is restricted from moving along the guide groove 310 by the locking protrusion 414. Here, when movement of the locking pin 100 is restricted by the locking protrusion 414, the first locking module 30 and the second locking module 40 are in the coupled state, and the cabin portion 10 and the driving portion 20 may maintain the assembled state therebetween.

As described above, the locking device of the prefabricated vehicle according to the disclosed embodiment is configured to quickly and readily assemble or disassemble the cabin portion 10 through which a passenger enters the vehicle with or from the driving portion 20 in charge of driving the vehicle. Through such a structural configuration, convenience of work and productivity may be improved.

In particular, the locking device of one embodiment that couples or decouples the first locking module 30 to and from the second locking module 40 by rotating the rotation guide 400 through spring force of the return spring 500 without using power has an advantage of excellent assembly performance through a configuration in which the cabin portion 10 is assembled with or disassembled from the driving portion 20 in a one-touch manner, thereby having an effect of completing work in a short period of time.

In addition, reliable and strong coupling may be implemented by the locking device of another embodiment that couples or decouples the first locking module 30 to or from the second locking module 40 by rotating the rotation guide 400 through power of the motor 700 without using the return spring 500, thereby having an advantage of improving durability.

As is apparent from the above description, a locking device of a prefabricated vehicle according to an embodiment is configured to quickly and readily assemble or disassemble a cabin portion through which a passenger enters the vehicle with or from a driving portion in charge of driving the vehicle, thereby having an effect of improving convenience of work and productivity.

Particularly, a locking device according to one embodiment that couples or decouples a first locking module to and from a second locking module by rotating a rotation guide through spring force of a return spring without using power may improve assembly performance through a configuration in which the cabin portion is assembled with or disassembled from the driving portion in a one-touch manner, thereby having an effect of completing work in a short period of time.

Further, reliable and strong coupling may be implemented by a locking device according to another embodiment that couples or decouples a first locking module to or from a second locking module by rotating a rotation guide through power of a motor without using a return spring, thereby having an effect of improving durability.

The effects of the present disclosure are not limited to the above-mentioned effects, and other effects not mentioned herein will be clearly understood by those skilled in the art from the detailed description of the embodiments.

Although embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A locking device comprising:
a locking pin;
a pin coupling portion configured to receive the locking pin;
a fixed guide having a guide groove configured to guide movement of the locking pin; and
a rotation guide rotatably installable so that it surrounds the fixed guide, the rotation guide having a locking groove configured to receive an end of the locking pin,
wherein the locking pin and the pin coupling portion form a first locking module arrangeable in a cabin portion or a driving portion,
wherein the fixed guide and the rotation guide form a second locking module arrangeable in the cabin portion or the driving portion so as to face the first locking module, and
wherein the cabin portion is assembled with or disassembled from the driving portion based on the first locking module being coupled to or decoupled from the second locking module.

2. The locking device according to claim 1,
wherein a plurality of pin coupling portions is fixedly connected to a plurality of portions of the driving portion, respectively, and
wherein a plurality of the locking pins is fixedly coupled to the pin coupling portions, wherein both ends of each of the locking pins protrude outwards from a corresponding one of the pin coupling portions.

3. The locking device according to claim 1,
wherein the fixed guide is fixedly coupled to the cabin portion at a location opposite to the pin coupling portion,
wherein the pin coupling portion is inserted into the fixed guide based on the first locking module being coupled to the second locking module,
wherein the guide groove is open toward a lower end of the fixed guide and extend upwards, and
wherein an end of the locking pin penetrates the guide groove.

4. The locking device according to claim 1,
wherein the locking groove is located in an inner circumferential surface of the rotation guide, and
wherein, when the locking pin is inserted into the locking groove and is located at an end of the locking groove, the locking pin is prevented from being separated from the guide groove and the locking groove so that the first locking module and the second locking module are in a coupled state and so that the cabin portion and the driving portion are in an assembled state.

5. The locking device according to claim 4, wherein the locking groove comprises:
an entry section opening toward a lower end of the rotation guide and extend upwards; and
a locking section extending in a circumferential direction of the rotation guide from an end of the entry section,
wherein one side of the entry section is an inclined surface and a locking protrusion is located between the inclined surface and the locking section,
wherein, when the locking pin is located at an end of the locking section, the locking pin is restricted from moving along the guide groove by the locking protrusion, and
wherein, when a movement of the locking pin is restricted by the locking protrusion, the first locking module and the second locking module are in the coupled state and the cabin portion and the driving portion are in the assembled state.

6. The locking device according to claim 5, further comprising a motor fixed to the cabin portion and connected to the rotation guide, wherein the motor is configured to rotate the rotation guide clockwise and counterclockwise.

7. The locking device according to claim 6,
wherein the rotation guide comprises a plurality of spokes extending radially from a central portion of the spokes, and
wherein a motor output shaft is connected to the central portion of the spokes.

8. The locking device according to claim 7,
wherein the fixed guide has spoke grooves configured for the spokes to be respectively inserted therein, and
wherein the spoke grooves are configured to restrict a rotation angle of the rotation guide by allowing movement of the respective spokes and contacting the respective spokes.

9. The locking device according to claim 7, wherein, when the guide groove and the entry section of the locking groove are connected to each other through rotation of the rotation guide by operation of the motor, the locking pin is movable along the guide groove and the entry section of the locking groove, thereby coupling or decoupling the first locking module from the second locking module and assembling or disassembling the cabin portion from the driving portion.

10. The locking device according to claim 7, wherein, when the locking pin is positioned at the end of the locking section through the rotation of the rotation guide, the locking pin is restricted from moving along the guide groove by the locking protrusion, and, when the locking pin is restricted by the locking protrusion, the first locking module and the second locking module remain coupled, maintaining the assembled state between the cabin portion and the driving portion.

11. The locking device according to claim 1, further comprising a return spring having one end coupled to the rotation guide and the other end coupled to the cabin portion so as to provide spring force to the rotation guide.

12. The locking device according to claim 11,
wherein, when the locking pin enters an entry section of the locking groove and moves to a maximum apex of a locking protrusion along an inclined surface, the rotation guide is rotated clockwise or counterclockwise such that the return spring is elastically deformed,
wherein, when the locking pin passes through the locking protrusion and enters the locking section, the return spring returns to an initial shape and transmits elastic force to the rotation guide such that the rotation guide is rotated in an opposite direction, and
wherein, when the locking pin is located at the end of the locking section by opposite rotation of the rotation guide, the locking pin is restricted from moving along the guide groove by the locking protrusion.

13. The locking device according to claim 12,
wherein the rotation guide has a stopper protrusion protruding outward in a radial direction of the rotation guide and extending in a circumferential direction,
wherein the stopper protrusion has a locking protrusion having a triangular cross section, the locking protrusion being an end of the stopper protrusion,
wherein the cabin portion has a dome portion configured for receiving the rotation guide, and
wherein the dome portion has a first hole configured for receiving the stopper protrusion, a second hole and a third hole configured for fixing the locking protrusion therein.

14. The locking device according to claim 13, wherein the first hole is circumferentially extending along an outer circumference of the dome portion so as to allow movement of the stopper protrusion when the rotation guide is rotated clockwise or counterclockwise.

15. The locking device according to claim 13,
wherein the second hole and the third hole are sequentially spaced apart from a side portion of the first hole, and
wherein, when the locking protrusion is fixedly locked in the third hole, the locking pin is not inserted into the locking groove or is located at the end of the locking section.

16. The locking device according to claim 15,
wherein, when the locking protrusion is fixedly locked in the third hole, a connection between the guide groove and the entry section of the locking groove is blocked by the locking protrusion, and
wherein the locking pin located at the end of the locking section is restricted from moving along the guide groove by the locking protrusion such that the first locking module and the second locking module maintain a coupled state and an assembled state between the cabin portion and the driving portion.

17. The locking device according to claim 15,
wherein the locking protrusion has an inclined surface and a right angle surface, and
wherein, when the first locking module is decouplable from the second locking module by a tool for removing the locking protrusion locked in the third hole.

18. The locking device according to claim 15, wherein the first locking module and the second locking module are arranged at a front space and at a rear space of a vehicle, and wherein the front space and the rear space are accessible by a hood and a trunk lid respectively.

19. The locking device according to claim 13,
wherein the second hole and the third hole are sequentially spaced apart from a side portion of the first hole, and
wherein, when the locking protrusion is fixedly locked in the second hole, the locking pin is moved out of the locking protrusion and is located at a connection point connecting the entry section to the locking section.

20. The locking device according to claim 19,
wherein, when the locking protrusion is fixedly locked in the second hole, the guide groove and the entry section of the locking groove are connected to each other, and
wherein the locking pin is movable along the guide groove and the entry section of the locking groove, enabling the first locking module to decouple from the second locking module and enabling the cabin portion to separate from the driving portion.
